(19) United States
(12) Patent Application Publication
(10) Pub. No.: US 2026/0010995 A1
(43) Pub. Date: Jan. 8, 2026

(54) METHOD AND DEVICE FOR THE ASSESSMENT OF A NUTRITIONAL COMPOSITION

(71) Applicant: N.V. NUTRICIA, Zoetermeer (NL)

(72) Inventors: Bernd STAHL, Utrecht (NL); Frederik Gerhard Johan TE HENNEPE, Utrecht (NL)

(73) Assignee: N.V. NUTRICIA, Zoetermeer (NL)

(21) Appl. No.: 19/326,807

(22) Filed: Sep. 12, 2025

Related U.S. Application Data
(63) Continuation of application No. PCT/EP2023/058692, filed on Apr. 3, 2023.

(51) Int. Cl. G06T 7/00; A23C 9/20; A23L 33/00; B65D 1/02

(52) U.S. Cl. CPC G06T 7/0002; A23C 9/206; A23L 33/40; B65D 1/0207; G06T 2207/10024; G06T 2207/30128

(57) ABSTRACT

A method performed by an electronic device assessing a first nutritional composition, obtaining (201, 301, 401) first visual information of the first nutritional composition; determining (202) whether there is a phase separation of the first nutritional composition based on the first visual information; if it is determined that there is a phase separation, determining (203) properties of at least one layer of the phase separation of the first nutritional composition based on the first visual information.

### FIELD OF THE INVENTION

The present invention relates to a composition and/or emulsion assessing method, apparatus, and computer implemented algorithm thereof. More specifically, the composition and/or emulsion assessment may be via phase separation, e.g., the composition and/or emulsion may be a nutritional composition such as mammary milk, infant formula prepared in water, and alike.

### BACKGROUND

A composition and/or an emulsion (including but not limit to suspension, dispersion, aqueous solution etc.) form of the composition may be assessed in order to determine the properties of the composition/emulsion, e.g., the components, the content of the components, quality, structure of the components, stability etc. For example, a mother may want to assess the quality of an infant nutritional composition before it is fed to her infant.

For example, WO2022/074004 A1 discloses a system for quantifying the volume fraction of a first phase in a dispersion, comprising a vessel for containing a sample of the dispersion, a centrifuge for centrifuging the vessel containing the dispersion, a computer program comprising instructions which, when the program is executed by a computer, cause the computer to carry out an image analysis algorithm on a digital photo obtained from the vessel after centrifugation to determine the size of the first phase and the size of the entire sample in the vessel.

Thus, in WO2022/074004 A1, the phase properties can only be determined after a centrifuging is performed to the dispersion, which is complex and difficult to perform in a home environment. For example, the mother may want to have an easy method to assess (e.g., the quality or other physical properties) of an infant formula at home, wherein the method in WO2022/074004 A1 would not be suitable.

Therefore, there is a need for an easy emulsion assessment method and device.

### SUMMARY OF THE INVENTION

It is a general desire that infant formula mimic human breast milk as close as possible. However, there are limited means for a parent to assess the similarity level of human milk and artificial infant milk formula. One way to determine the similarity level is to compare the ingredient composition of the infant formula with the chemical composition of human milk. But it would be extremely difficult, time-consuming and costly. Therefore, the present invention provides a first method performed by an electronic device assessing a nutritional composition.

The present invention provides a method for determining the similarity level of human milk with infant milk formula. Human milk is known to have some special visible effects including a creaming effect when milk pumped from the breast is left resting. This creaming effect is due to the phase separation within the breast milk and can be observed via two different layers formed in the bottle containing the breast milk. This creaming effect is the result of the specific composition of human milk.

In a preferred embodiment, the present invention provides a method for determining to what extent an artificial infant formula has this creaming effect and thereby providing an indication on the closeness of the artificial infant formula to human milk. This can be done by a method using a mobile device with a camera, obtaining visual information for a bottle of infant milk formula that has been prepared, well mixed and left resting for an amount of time. By determining the formation of different layers within the infant formula bottle (i.e., the phase separation/the creaming effect), the closeness to human milk can be determined.

In one embodiment, the present invention relates to an emulsion assessing method, apparatus, and computer implemented algorithm thereof. More specifically, the emulsion assessment may be via phase separation, e.g., the emulsion being a nutritional composition such as infant formula in water, mammary milk and alike.

Surprisingly the inventors have found that the methods of the invention can provide convenient, efficient and cost-saving solutions to determine the type, quality, properties etc. of nutritional compositions. The solutions can further help users/parents to determine the similarity level of formulas and human milk, more specifically can even determine the similarity level of formulas and individual human milk (each mother's human milk can be slightly different). The solutions of the invention are significantly helpful to the families having babies. Especially, the solutions can be valuable tools for new parents, so that they can quickly select the suitable supplementary food for their babies.

### BRIEF DESCRIPTION OF THE DRAWINGS

The present invention will be discussed in more detail below, with reference to the attached drawings, in which:

FIG. 1A shows an example of homogeneous emulsion.

FIG. 1B shows an example of a phase separation of emulsion.

FIG. 1C shows a photo of a phase separation of human milk.

FIG. 1D shows a photo of a phase separation of an example infant formula.

FIG. 2 shows a method to assess an emulsion, e.g., a nutritional composition.

FIG. 3 shows a method to assess an emulsion, e.g., a nutritional composition.

FIG. 4. shows a method to assess an emulsion, e.g., a nutritional composition.

FIG. 5 shows an apparatus to perform the method.

### DESCRIPTION OF EMBODIMENTS

The present invention preferably provides a method to assess emulsion based on phase separation. A phase separation may be the separation of two or more distinct phases from a homogeneous mixture (e.g., emulsion in a homogeneous state, or called homogeneous emulsion), after the mixture has been prepared and left standing for a certain period of time (not disturbed). Phase separation preferably relates to the spontaneous formation of a liquid into a dense and a dilute phase. The present invention preferably relates to the assessment of a liquid that has two phases following a spontaneous phase separation. The different phases of the liquid can be determined, preferably by a difference in transparency of the phases of the one liquid.

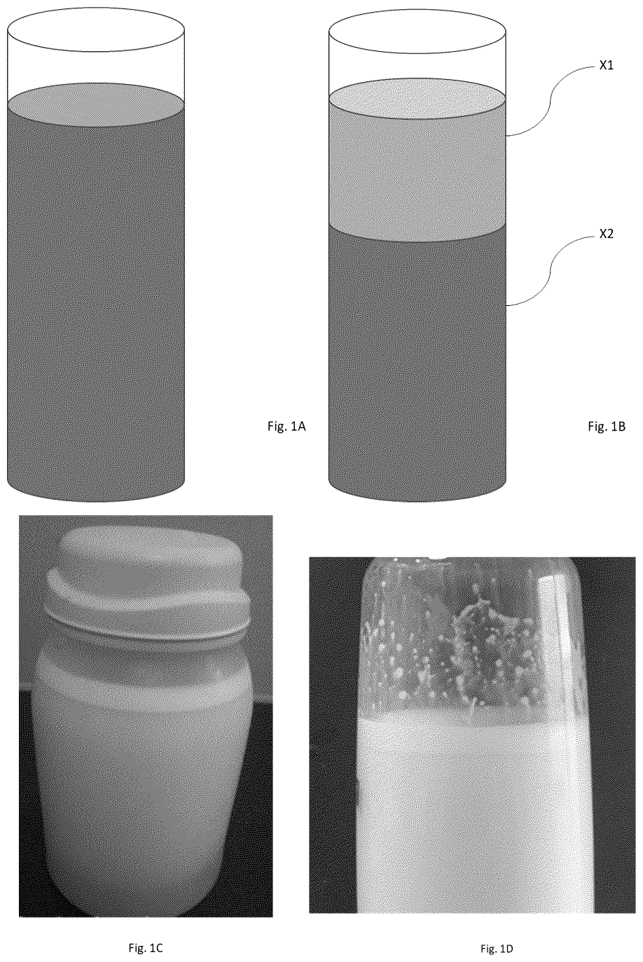

FIG. 1A shows an example of a homogeneous emulsion, wherein the compositions are mixed evenly and there is no phase separation. However, after a certain period of time, different phases within the homogeneous emulsion start to separate from each other as shown in FIG. 1B.

The present invention provides a method to assess the emulsion via the phase separation because the properties of the distinct phases after the phase separation can provide some indications on the different compositions and the composition ratios in the emulsion. Furthermore, emulsions with similar compositions should have similar phase separation properties as well. Thus, phase separation properties may be used to further determine the quality of the emulsion, either directly according to the properties or indirectly comparing the properties with those of a reference emulsion.

The phase separation properties may be some physical characteristic of each of the phases, for example, the color, the thickness and/or the translucency. For example, a mother may easily assess whether a nutritional composition (such as an infant formula) is with a reasonable quality by directly assessing the phase separation (e.g., properties) of the nutritional composition and/or preferably comparing the phase separation to a phase separation of a reference infant nutritional composition (such as human milk or a reference infant formula).

FIG. 1C shows a photo of a phase separation of human milk in a transparent bottle. The creaming effect/phase separation of the human milk can be identified in FIG. 1C wherein there are a top layer with lighter color and a bottom layer with a darker color.

FIG. 1D shows a photo of a phase separation of an example infant formula. The creaming effect/phase separation of the infant formula can be identified as well, wherein there are a top layer with lighter color and a bottom layer with a darker color. Thus, by comparing the color, the thickness, the translucency of the top and bottom layers between FIG. 1C and FIG. 1D, a level of similarity between the human milk and the infant formula may be determined.

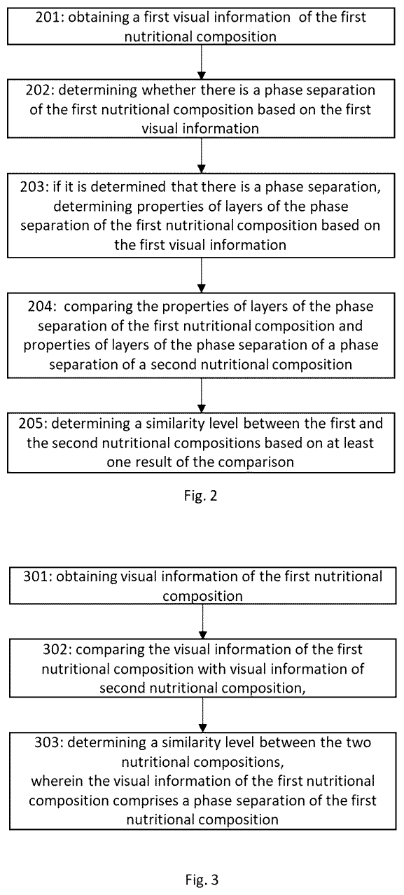

FIG. 2 shows a method to assess an emulsion, wherein a nutritional composition is used as an example. Each of the steps in FIG. 2 may be optional, e.g., any one or more of steps 201 to 205 may be omitted from the method.

Preferably the emulsion to be assessed may be a nutritional composition, which may be an infant nutritional composition suitable for infants, e.g., aging from 0 to 12 months. The infant nutritional composition may be any of an infant formula or follow-on formula (e.g., a ready-to-drink composition after reconstitution of a powder with water), mammary milk (e.g., mammary gland excretion product such as cow milk, human milk, goat milk, etc.), vegan milk product (e.g., soy milk, almond milk, oat milk, etc.), and alike.

Preferably, the nutritional composition comprises carbohydrates, proteins and lipids. Preferably the protein are at least partially obtained from cow milk. Preferably the composition contains lactose. Preferably the lipid is in the form of lipid globules and wherein
a. the lipid globules may have a mode diameter, based on volume, of at least 1.0 μm; and/or
b. at least 45 volume %, based on total lipid volume, of the lipid globules may have a diameter of 2 to 12 μm.

A suitable method to determine the volume of lipid globules and their size distribution is by using a Mastersizer particle size analyzer (Malvern Instruments, Malvern, UK), for example by the method described in Michalski et al, 2001, Lait 81:787-796.

Preferably, the nutritional composition may comprise non-digestible carbohydrates. The non-digestible carbohydrates may be prebiotic oligosaccharides, more preferably prebiotic oligosaccharides selected from fructo-oligosaccharides (FOS), galacto-oligosaccharides (GOS), or mixtures thereof.

A phase separation of a nutritional composition may include the separation of the lipid component from the emulsion leaving a more aqueous component, wherein the lipid component will be above the aqueous component. Eventually, a first (upper) layer is formed, e.g., with more lipid, and a second (lower) more aqueous layer is formed, e.g., comprising water soluble ingredients and less lipid compared to the upper layer. In the context of this invention, this phase separation may be called a creaming effect because a lipids/creamy layer is formed on top of the nutritional composition.

The level/properties of phase separation for the nutritional composition may depend on how long the nutritional composition is left undisturbed. In an preferred embodiment, phase separation of the nutritional composition is determined at a predetermined time after the preparation, wherein the preparation is the mixing of an infant formula powder with a predetermined volume of water. For example, the longer left undisturbed after its preparation, the higher degree of the phase separation, e.g., first layer is thicker. After a certain period, the level of phase separation may reach a maximum level and the first layer will not increase anymore.

In the method of FIG. 2, a first nutritional composition may be assessed. In step 201, a first visual information of the first nutritional composition is obtained. The first visual information may comprise at least one of an image, a video, a three-dimensional scan of the first nutritional composition or any other means. In this document, the term “image” is used as an example of “visual information”, i.e., the invention includes general “visual information” even if the term “image” is used.

The first visual information may be obtained via a camera of the device that is performing the method, or obtained via an external device (e.g., from a server via the Internet, directly from another device with a direct communication protocol, etc.).

Before the first visual information may be obtained, the first nutritional composition may be prepared in a homogeneous mixture state and left for a predetermined time. For example, if the first nutritional composition is a composition containing protein, lipid and carbohydrate, the homogeneous mixture state may be a state of the formula when the formula powder is reconstituted with water and well mixed, i.e., the formula powder being dissolved in the water; if the first nutritional composition is mammal milk, the homogeneous mixture state may be the state of the mammal milk when the mammal milk is just excreted from mammary gland or mixed well again into a homogeneous state after a phase separation. For example, when the composition already has a phase separation, the composition may be mixed/shaken into a single homogeneous mixture again.

Preferably, the first nutritional composition is not human milk. E.g., it is an infant formula to be compared with human milk.

Thus, the first visual information is preferably obtained after a predetermined time period when the first nutritional composition is in a homogeneous state and undisturbed. Preferably, the first visual information is obtained when the first nutritional composition has been standing for a predetermined time period.

The first visual information is preferably a visual information of a container which contains the first nutritional composition. Preferably, the container is a bottle, a cup, a glass, a plastic bag, paper box, more preferably a bottle. The container is preferably transparent or semi-transparent such that the phase separation may be visible in the first visual information.

In step 202, it is determined whether there is a phase separation of the first nutritional composition based on the first visual information. When there are distinguishable layers in the first visual information for the first nutritional composition, it may be determined that there is a phase separation. Preferably it is determined whether the visual information contains distinguishable layers in the first nutritional composition. The distinguishable layers are preferably recognized based on the color difference or translucency difference within the first nutritional composition.

If it is determined that there is no phase separation, the method may comprise a step to remind the user to leave the first nutritional composition for a longer period, or merely output that there is no phase separation.

In step 203, if it is determined that there is a phase separation, one or more properties of at least one layer (e.g., the top/first layer or both top/first and bottom/second layers) of the phase separation of the first nutritional composition based on the first visual information are determined. A first phase separation of the first nutritional composition in the first visual information is determined, wherein the determining of the first phase separation comprises determining properties of at least one layer of the first phase separation. The properties of the layers are used in the same way as the phase separation properties as described herein, i.e., properties may be used interchangeably.

The first phase separation preferably comprises at least a first layer of the first nutritional composition and a second layer of the first nutritional composition, and the first layer is preferably above the second layer in the first nutritional composition. The first layer preferably contains more lipid than the second layer, and the second layer is preferably more aqueous. The second layer preferably comprising water soluble ingredients and less lipid compared to the upper layer.

The properties of the layers preferably comprise at least one of the thickness of a layer, translucency of a layer, color of a layer, and thickness ratio, translucency ratio and/or color ratio between the two layers (e.g., between the first and second layers).

The properties of the first and second layers preferably comprise at least one of the following: a thickness of the first layer, a translucency of the first layer, a thickness of the second layer, a translucency of the second layer, a color of the first layer, a color of the second layer, a thickness ratio between the first layer and the second layer, a translucency ratio between the first layer and the second layer; and a color ratio between the first layer and the second layer.

The first phase separation may be determined by at least one of pattern recognition, color recognition and an artificial intelligence model.

Preferably, the determination of the first phase separation preferably comprises at least one of: (i) the determining the colors of some or all pixels in the first visual information, (ii) recognizing the nutritional composition and background, (iii) recognizing the first layer and the second layer in the nutritional composition, (iv) determining the average colors of the first and second layers, (v) determining the thickness of the first and second layers; and (vi) determining the translucency of the first and second layers.

Recognizing the nutritional composition and background is preferably via at least one of the color differences between pixels, with pattern recognition technology to recognize the container shape (i.e., with the nutritional composition in the container), or via a trained AI model. In this step, the visual information area for the nutritional composition may be distinguished from the remaining area in the first visual information. The remaining area may be called the background, or the background area in the first visual information.

Recognizing the first layer and the second layer may be according to the color differences between pixels of the nutritional composition in the first visual information, e.g., within the visual information area for the nutritional composition. For example, all the pixels in this area may be examined to determine whether they are in the same layer and then the upper layer may be determined to be the first layer and the lower layer may be determined to be the second layer. For example, if a color difference (at least one of the absolute value or the difference ratio) between two pixels within the nutritional composition is higher than a predetermined threshold, then these two pixels may be categorized into two different layers. Depending on the positions of the pixels, the upper pixel may be determined as in the first layer and the lower pixel may be determined as the second layer. Alternatively, both the color difference and the distance between two pixels within the nutritional composition visual information area may be based on in order to recognize the layers, e.g., the layer determination of two pixels may be a function with two parameters (i.e., the color difference and distance). For example, the color difference between the two pixels may be given more given more weight to distinguish two layers if the distance between the two pixels is longer, and the distance between the two pixels may be given more weight to distinguish two layers when if the distance between the two pixels is shorter.

Alternatively, the first layer and the second layer may be reorganized according to pattern recognition technology based on the expected/pre-assumed shapes/colors of the layers. A trained AI model may be used to recognize the first layer and the second layer as well.

The average color of a layer may be the average color of all the pixels of the layer, or the color of one or more certain pixels of the layer (e.g., in the middle/center region). A trained AI model may be used to determine the average color of a layer.

The thickness of a layer may be determined according to the number of pixels or the total length of the pixels, e.g., on the vertical direction. The thickness may be an average thickness of the whole layer or a certain section of the layer (e.g., the middle section). A trained AI model may be used to determine the thickness of a layer.

The determining of the translucency of the first and second layers may be according to the color difference between a layer of the nutritional composition and the background. For example, a layer has a higher translucency if the color difference between a layer and its background is smaller. The background of a layer may be a subarea of the background area which is within a predetermined distance with the layer in the first visual information, by which way a first subarea of the background area may be determined for the first layer and a second subarea of the background area may be determined for the second layer in the first visual information.

For example, the color difference between the first layer and its corresponding first subarea of the background area may be used as an indication of translucency of the first layer. If the color difference is higher, than the translucency level is lower. Similarly for the second layer, such a color difference may be used to determine the translucency of the second layer.

A dark-colored background may be used in the first visual information when it is taken, in order to increase the accuracy for the translucency determination.

Alternatively, the translucency may be determined only based on the color of the layers, for example, a lighter color may indicate a higher translucency of the layer. An average translucency for each layer may also be obtained. A trained AI model may be used to determine the translucency of a layer.

Based on the properties, the quality of the first nutritional composition may be assessed based on reference properties, e.g., the reference properties may be the phase separation properties of a reference emulsion (such as a reference/second nutritional composition like human milk).

Step 204 may be optional, i.e., comparing the properties of at least one layer of the phase separation of the first nutritional composition and properties of at least one layer of the phase separation of a phase separation of a second nutritional composition. In step 204, the first phase separation of the first nutritional composition may be compared to a second phase separation of the second nutritional composition. The comparing may be performed according to the comparison of the properties of the two phase separations, e.g., calculating/comparing the difference or ratios for any of the properties.

The second nutritional composition may be a reference composition that is desired to compare with, which (also) has a phase separation after the predetermined time. The phase separation properties of the second nutritional composition may be compared with those of the first nutritional composition in order to determine the similarity level of the two compositions.

The first nutritional composition may be an infant formula or follow-on formula and the second nutritional composition may be human milk.

The second phase separation of the second nutritional composition may be after the second nutritional composition is prepared for the predetermined time period. The second phase separation may comprise at least a third layer of second nutritional composition and a fourth layer of second nutritional composition, and the third layer is above the fourth layer in the second nutritional composition.

The properties of the third and fourth layers may comprise at least one of the parameters comprising a thickness of the third layer, a translucency of the third layer, a thickness of the fourth layer, a translucency of the fourth layer, a color of the third layer, a color of the fourth layer, a thickness ratio between the third layer and the fourth layer, a translucency ratio between the third layer and the fourth layer, a color ratio between the first third and the fourth layer.

Step 205 is also optional, i.e., determining a similarity level between the first and the second nutritional compositions based on at least one result of the comparison. In step 205, a similarity level between the first and the second nutritional compositions based on at least one result of the comparison may be determined. For example, the similarity level may be determined based on the at least one result of the comparing and at least one corresponding predetermined threshold, e.g., according to a mapping table to map the difference of properties to a similarity score, or according to a mathematical formula with the properties of the two-phase separations as input to calculate a similarity score.

The at least one result of the comparing may comprise at least one of a thickness difference of the first layer and the third layer, a thickness difference of the second layer and the fourth layer, a translucency difference of the first layer and the third layer, a translucency difference of the second layer and the fourth layer, a color difference of the first layer and the third layer, a color difference of the second layer and the fourth layer, a difference between a thickness ratio between the first layer and the second layer and a thickness ratio between the third layer and the fourth layer, a difference between a translucency ratio between first layer and the second layer and a translucency ratio between the third layer and the fourth layer, and a difference between a color ratio between first layer and the second layer and a color ratio between the third layer and the fourth layer.

The method in FIG. 2 may further comprise a step of obtaining a second visual information of the second nutritional composition after the second nutritional composition is prepared for the predetermined time period, and/or determining the second phase separation in the second visual information, i.e., with a similar way as for the first phase separation in the first visual information as disclosed above for step 202.

Alternatively, before the comparing of the similarity level between the phase separation properties of the first nutritional composition and the phase separation properties of the second composition in step 205 may use predetermined and/or pre-stored property data of the phase separation of the second composition. I.e., the phase separation properties of the first nutritional composition may be determined based on the first visual information, but the phase separation properties of the second nutritional composition may be predetermined and/or pre-stored property data.

In the method in FIG. 2, the phase separation may be determined by a first artificial intelligence model, and/or the first phase separation and the second phase separation may be compared by a second artificial intelligence model.

Alternatively, the determining of the first phase separation, the comparing of the first phase separation to the second phase separation, and the determining of the similarity level between the first and second nutritional compositions may be via a single artificial intelligence model.

In the method of FIG. 2, the predetermined time period may comprises at least one or more time points, and the first phase separation may comprise a first series of vectors of properties. Each of the vectors of properties of the first phase separation may correspond to each of the time points, and/or the second phase separation may comprise a second series of vectors of properties, each of the vectors of properties of the second phase separation may correspond to each of the time points.

The properties of the first/second phase separation may be determined at a series of multiple time points, which may form a series of vectors of properties, and each vector of properties is determined at a time point. For example, vector Vi(tj)=<color-i(tj), translucency-i(tj), . . . > may be formed; i may be 1 or 2 to indicate whether the vector and the property (e.g., color, translucency, etc.) are for the first or the second phase separation. tj indicates a time point j.

The similarity levels at different time points may be determined, for example, both at time t1 and t2. t1 is a time point after the first and second compositions are prepared, and t2 is a time point after the first and second compositions are prepared (starting from a homogeneous state), etc. This may increase the accuracy of assessing the similarity between the two compositions by comparing additional parameters, e.g., the phase separation speed/phase separation speed, the properties during the phase separating process, the trajectory of the phase separation, etc.

A regression between the first and the second series of vectors of properties may be performed when determining the similarity level.

FIG. 3 shows a method for assessing an emulsion, which is similar to FIG. 2 and can be combined with FIG. 2.

In step 301, visual information of the first nutritional composition is obtained which is the same as in step 201.

In step 302, the visual information of the first nutritional composition and visual information of a second nutritional composition are compared. At least the first nutritional composition may comprise a phase separation of the first nutritional composition, and the phase separation properties may be compared.

The comparing of the visual information may be similar as in in step 204,

i.e., step 202 is omitted. The difference between step 302 and step 204 is that in step 204, the properties are directly obtained wherein the properties of the second nutritional composition may be directly obtained, e.g., according to predetermined or pre-measured properties of the second nutritional composition. However, in step 302, the properties of the second nutritional composition may be obtained in the second visual information first, which may be similar as in step 203 where the properties of the first nutritional composition are determined based on the first visual information.

In step 303, similarity level between the two nutritional compositions is determined, which is similar as in step 205.

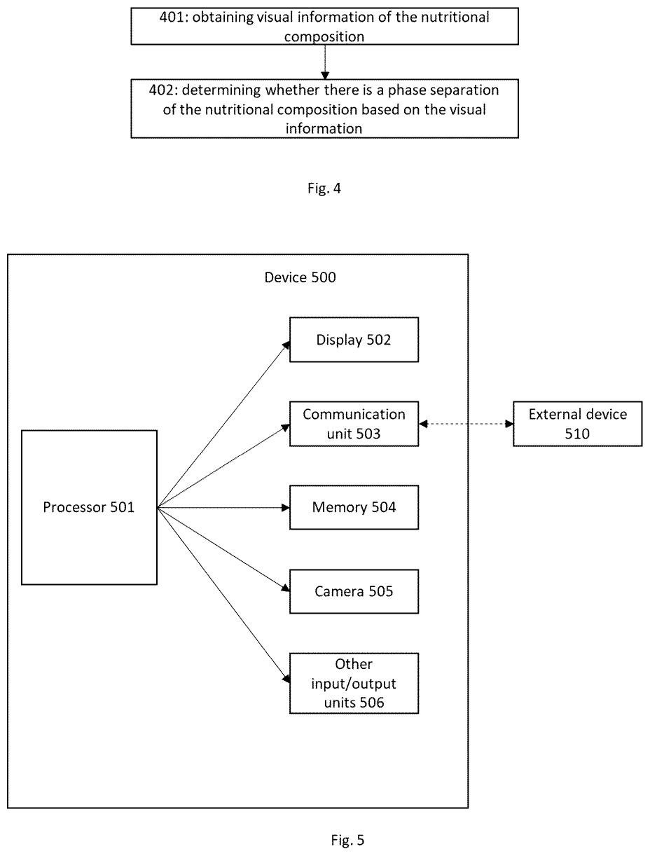

FIG. 4 shows a method for assessing an emulsion, which is similar to FIGS. 2 and 3 and can be combined with any or both of FIGS. 2 and 3.

In step 401, visual information of the first nutritional composition is obtained which is the same as in step 201.

In step 402, whether there is a phase separation of the nutritional composition based on the visual information is determined, which is the same as in step 202.

FIG. 5 shows a device 500 which can perform the methods in any of FIGS. 2 to 4, e.g., a mobile phone, tablet, laptop, desktop, smart watch, a TV, etc., to perform the present invention.

The device 500 may comprise a processor 501, a display 502, a communication unit 503, a memory 504, a camera 505 and other input/output units 506.

The processor 501 is configured to perform the program/instructions stored in the memory 504, e.g., via controlling other components such as the display 502, the communication unit 503, the memory 504, the camera 505 and other input/output units 506.

The display 502 may be controlled by the processor 501 to perform all the displaying function (and input function if it is a touch screen) according to the present invention, e.g., when the visual information is obtained, the visual information may be displayed, and/or when the similarity level is determined, it may be output on the display 502.

The communication unit 503 may be controlled by the processor 501 to perform all communication function in the present invention. For example, if an external device 510 (e.g., a sever) is used to perform some of or all the identifying functions according to the present invention, e.g., some of the steps 201 to 205, 301 to 303 and 401 to 402, messages are communicated via the communication unit 503, such as transmitting the visual information and/or receiving the similarity level. Optionally, the visual information may be not stored in the external device 510 for privacy reasons, e.g., after each identifying step, the image is immediately deleted in the external device 510.

The memory 504 is configured to store software, program and/or data. For example, the visual information, the determined properties of the layers, the determined similarity level may be saved in the memory 504.

The camera 505 is configured to capture visual information according to the present invention, e.g., in steps 201, 301 and 401.

The other input/output units 506 are configured to perform other input/output functions of the present invention, for example, to out audio notifications or receive user input for taking the visual information (e.g., to start recording a video) and/or any other use settings.

According to the present invention, at least a part of the device (e.g., FIG. 5) or method (e.g., FIGS. 2 to 4) may be implemented as instructions stored in a non-transitory computer-readable storage medium, e.g., in the form of a program module, a piece of software, a mobile app, and/or other forms. The instructions, when executed by a processor (e.g., the processor 501), may enable the processor to carry out a corresponding function according to the present invention. The non-transitory computer-readable storage medium may be e.g., the memory 504.

The present invention relates to a method performed by an electronic device assessing a first nutritional composition, comprising obtaining first visual information of the first nutritional composition; determining whether there is a phase separation of the first nutritional composition based on the first visual information; if it is determined that there is a phase separation, determining properties of at least one layer of the phase separation of the first nutritional composition based on the first visual information.

The method further may comprise comparing the properties of at least one layer of the phase separation of the first nutritional composition and the properties of at least one layer of the phase separation of a phase separation of a second nutritional composition, and determining a similarity level between the first and the second nutritional compositions based on at least one result of the comparison.

The first visual information may be obtained when the first nutritional composition has been standing for a predetermined time period.

The first nutritional composition may be an infant formula or follow-on formula and the second nutritional composition is human milk.

The visual information may comprise at least one of an image, a video or a three-dimensional scan of the first nutritional composition.

The nutritional composition may comprise carbohydrates, protein, lipid and vitamin, wherein the lipid may be in the form of lipid globules and wherein a. the lipid globules may have a. a mode diameter, based on volume, of at least 1.0 μm; and/or b. at least 45 volume %, based on total lipid volume, of the lipid globules may have a diameter of 2 to 12 μm.

The nutritional composition may comprise non-digestible carbohydrates.

The non-digestible carbohydrates may be prebiotic oligosaccharides, preferably prebiotic oligosaccharides selected from fructo-oligosaccharides (FOS), galacto-oligosaccharides (GOS), or mixtures thereof.

The phase separation of the first nutritional composition may comprise at least a first layer of the first nutritional composition and a second layer of the first nutritional composition, and the first layer may be above the second layer in the first nutritional composition.

The phase separation of the second nutritional composition may be after the second nutritional composition has been standing for the predetermined time period, the phase separation of the second nutritional composition may comprise at least a third layer of the second nutritional composition and a fourth layer of the second nutritional composition, and the third layer may be above the fourth layer in the second nutritional composition.

The method may further comprise obtaining second visual information of the second nutritional composition after the second nutritional composition has been standing for the predetermined time period, and determining properties of at least one layer of the phase separation of the second nutritional composition based on the second visual information; or the properties of at least one layer of the phase separation of the second nutritional composition may be predetermined or prestored.

The properties of at least one layer of the phase separation of the first nutritional composition may comprise properties of the first and second layers, which may comprise at least one of a thickness of the first layer, a translucency of the first layer, a thickness of the second layer, a translucency of the second layer, a color of the first layer, a color of the second layer, a thickness ratio between the first layer and the second layer, a translucency ratio between the first layer and the second layer, a color ratio between the first layer and the second layer.

The properties of at least one layer of the phase separation of the second nutritional composition may comprise the properties of the third and fourth layers, which may comprise at least one of a thickness of the third layer, a translucency of the third layer, a thickness of the fourth layer, a translucency of the fourth layer, a color of the third layer, a color of the fourth layer, a thickness ratio between the third layer and the fourth layer, a translucency ratio between the third layer and the fourth layer, a color ratio between the first third and the fourth layer.

The at least one result of the comparing may comprise at least one of a thickness difference of the first layer and the third layer, a thickness difference of the second layer and the fourth layer, a translucency difference of the first layer and the third layer, a translucency difference of the second layer and the fourth layer, a color difference of the first layer and the third layer, a color difference of the second layer and the fourth layer, a difference between a thickness ratio between the first layer and the second layer and a thickness ratio between the third layer and the fourth layer, a difference between a translucency ratio between first layer and the second layer and a translucency ratio between the third layer and the fourth layer, and a difference between a color ratio between first layer and the second layer and a color ratio between the third layer and the fourth layer.

The similarity level may be determined based on the at least one result of the comparing and at least one corresponding predetermined threshold.

The first phase separation may be determined by at least one of pattern recognition, color recognition and an artificial intelligence model.

The first visual information may contain a bottle, wherein the first nutritional composition may be prepared in the bottle and the bottle may be made of a transparent material.

The predetermined time period may comprise at least one or more time points, and the phase separation of the first nutritional composition may comprise a first series of vectors of properties of at least one layer, each of the vectors of properties of at least one layer corresponding to each of the time points, and/or the phase separation of the second nutritional composition may comprise a second series of vectors of properties of at least one layer, each of the vectors of properties of at least one layer corresponding to each of the time points.

The present invention relates to a method performed by an electronic device assessing a first nutritional composition, comprising obtaining visual information of the first nutritional composition, comparing the visual information of the first nutritional composition with visual information of a second nutritional composition, determining a similarity level between the two nutritional compositions, wherein the visual information of the first nutritional composition may comprise a phase separation of the first nutritional composition, and the visual information of the second nutritional composition may comprise a phase separation of the second nutritional composition.

The present invention relates to a method performed by an electronic device for assessing a nutritional composition, comprising obtaining visual information of the nutritional composition, determining whether there is a phase separation of the nutritional composition based on the visual information via determining whether two or more layers are present in the nutritional composition, and/or where there may be difference between a top layer and a bottom layer in the nutritional composition.

The nutritional composition may be not fresh mammalian milk, preferably not human milk.

The nutritional composition may be in a transparent or semi-transparent container.

The present invention relates to an electronic device which is configured to perform any of the methods.

The present invention relates to a kit with a container and an electronic device configured to perform any of the methods, wherein the first nutritional composition may be prepared within the container, and/or the first visual information may be visual information of the first nutritional composition with the container.

The present inventio relates to a storage medium comprising program instructions to instruct an electronic device to perform any of the methods.

1. A method performed by an electronic device assessing a first nutritional composition, comprising
obtaining first visual information of the first nutritional composition;
determining whether there is a phase separation of the first nutritional composition based on the first visual information;
if it is determined that there is a phase separation, determining properties of at least one layer of the phase separation of the first nutritional composition based on the first visual information.

2. The method according to claim 1, wherein the method further comprises comparing the properties of at least one layer of the phase separation of the first nutritional composition and properties of at least one layer of the phase separation of a phase separation of a second nutritional composition, and
determining a similarity level between the first and the second nutritional compositions based on at least one result of the comparison.

3. The method according to any of the preceding claims, wherein the first visual information is obtained when the first nutritional composition has been standing for a predetermined time period.

4. The method according to any of the preceding claims, wherein the first nutritional composition is an infant formula or follow-on formula and/or the second nutritional composition is human milk.

5. The method according to any of the preceding claims, wherein the visual information comprises at least one of an image, a video or a three-dimensional scan of the first nutritional composition.

6. The method according to any of the preceding claims, wherein the nutritional composition comprises carbohydrates, protein, lipid and vitamin, wherein the lipid is in the form of lipid globules and wherein
a. the lipid globules have a mode diameter, based on volume, of at least 1.0 μm; and/or
b. at least 45 volume %, based on total lipid volume, of the lipid globules have a diameter of 2 to 12 μm.

7. The method according to any of preceding claims, wherein the nutritional composition comprises non-digestible carbohydrates.

8. The method according to any of preceding claims, wherein the non-digestible carbohydrates are prebiotic oligosaccharides, preferably prebiotic oligosaccharides selected from fructo-oligosaccharides (FOS), galacto-oligosaccharides (GOS), or mixtures thereof.

9. The method according to any of the preceding claims, wherein the phase separation of the first nutritional composition comprises at least a first layer of the first nutritional composition and a second layer of the first nutritional composition, and the first layer is above the second layer in the first nutritional composition.

10. The method according to any of the preceding claims, wherein the phase separation of the second nutritional composition is after the second nutritional composition has been standing for the predetermined time period, the phase separation of the second nutritional composition comprises at least a third layer of the second nutritional composition and a fourth layer of the second nutritional composition, and the third layer is above the fourth layer in the second nutritional composition.

11. The method according to any of the preceding claims, wherein the method further comprises, obtaining second visual information of the second nutritional composition after the second nutritional composition has been standing for the predetermined time period, and determining properties of at least one layer of the phase separation of the second nutritional composition based on the second visual information.

12. The method according to any of the preceding claims, wherein the properties of at least one layer of the phase separation of the first nutritional composition comprise properties of the first and second layers, which comprises at least one of a thickness of the first layer, a translucency of the first layer, a thickness of the second layer, a translucency of the second layer, a color of the first layer, a color of the second layer, a thickness ratio between the first layer and the second layer, a translucency ratio between the first layer and the second layer, a color ratio between the first layer and the second layer; and/or
wherein the properties of at least one layer of the phase separation of the second nutritional composition comprise the properties of the third and fourth layers, which comprises at least one of a thickness of the third layer, a translucency of the third layer, a thickness of the fourth layer, a translucency of the fourth layer, a color of the third layer, a color of the fourth layer, a thickness ratio between the third layer and the fourth layer, a translucency ratio between the third layer and the fourth layer, a color ratio between the first third and the fourth layer.

13. The method according to any of the preceding claims, wherein the at least one result of the comparing comprises at least one of a thickness difference of the first layer and the third layer, a thickness difference of the second layer and the fourth layer, a translucency difference of the first layer and the third layer, a translucency difference of the second layer and the fourth layer, a color difference of the first layer and the third layer, a color difference of the second layer and the fourth layer, a difference between a thickness ratio between the first layer and the second layer and a thickness ratio between the third layer and the fourth layer, a difference between a translucency ratio between first layer and the second layer and a translucency ratio between the third layer and the fourth layer, and a difference between a color ratio between first layer and the second layer and a color ratio between the third layer and the fourth layer.

14. The method according to any of the preceding claims, wherein the similarity level is determined based on the at least one result of the comparing and at least one corresponding predetermined threshold.

15. The method according to any of the preceding claims, wherein the first phase separation is determined by at least one of pattern recognition, color recognition and an artificial intelligence model.

16. The method according to any of the preceding claims, wherein the first visual information contains a bottle, wherein the first nutritional composition is prepared in the bottle and the bottle is made of a transparent material.

17. The method according to any of the preceding claims, wherein the predetermined time period comprises at least one or more time points, and the phase separation of the first nutritional composition comprises a first series of vectors of properties of at least one layer, each of the vectors of properties of at least one layer corresponding to each of the time points, and/or the phase separation of the second nutritional composition comprises a second series of vectors of properties of at least one layer, each of the vectors of properties of at least one layer corresponding to each of the time points.

18. A method performed by an electronic device assessing a first nutritional composition, comprising
obtaining visual information of the first nutritional composition,
comparing the visual information of the first nutritional composition with visual information of a second nutritional composition,
determining a similarity level between the two nutritional compositions, wherein the visual information of the first nutritional composition comprises a phase separation of the first nutritional composition, and the visual information of the second nutritional composition comprises a phase separation of the second nutritional composition.

19. A method performed by an electronic device for assessing a nutritional composition, comprising
obtaining visual information of the nutritional composition,
determining whether there is a phase separation of the nutritional composition based on the visual information via determining whether two or more layers are present in the nutritional composition, and/or where there is difference between a top layer and a bottom layer in the nutritional composition.

20. The method according to any of the preceding claims, wherein the nutritional composition is not fresh mammalian milk, preferably not human milk.

21. The method according to any of the preceding claims, wherein the nutritional composition is in a transparent or semi-transparent container.

22. An electronic device which is configured to perform any of the methods.

23. A kit with a container and an electronic device configured to perform any of the methods, wherein the first nutritional composition is prepared within the container, and/or the first visual information is visual information of the first nutritional composition with the container.

24. A storage medium comprising program instructions to instruct an electronic device to perform any of the methods.
